(19) United States
(12) Patent Application Publication
(10) Pub. No.: US 2011/0170944 A1
(43) Pub. Date: Jul. 14, 2011

(54) METHOD FOR THE PRODUCTION OF A BALL JOINT, AND A BALL JOINT

(75) Inventor: Hans-Gerd Oellers, Moenchengladbach (DE)

(73) Assignee: TRW AUTOMOTIVE GMBH, Alfdorf (DE)

(21) Appl. No.: 12/301,825

(22) PCT Filed: May 23, 2007
(86) PCT No.: PCT/EP2007/004574

§ 371 Date: Mar. 28, 2011

(30) Foreign Application Priority Data
May 23, 2006 (DE) 10 2006 024 198.3

(51) Int. Cl. F16C 11/06; B23K 11/00

(52) U.S. Cl. 403/122; 219/148

(57) ABSTRACT

The invention relates to a method for the production of a ball joint, in which a cover is electrically welded to a housing, the cover or the housing having at least one spacer which keeps the cover at an excessively great distance from the housing before welding, and in which then the current flowing during welding is controlled or regulated in such a way that the at least one spacer melts by a predetermined amount so that the cover is mounted in a prestressed manner on the housing. The invention further relates to a ball joint with a housing, a link pin, a bearing box and a cover which braces the bearing box in the housing, the cover being provided with at least one spacer which is welded electrically to the housing so that its height has reduced to a predetermined extent.

### CROSS-REFERENCE TO RELATED APPLICATIONS

This application claims priority to International Patent Application No. PCT/EP2007/004574 filed May 23, 2007, the disclosures of which are incorporated herein by reference in entirety, and which claimed priority to German Patent Application No. 10 2006 024 198.3 filed May 23, 2006, the disclosures of which are incorporated herein by reference in entirety.

### BACKGROUND OF THE INVENTION

The invention relates to a ball joint with a housing, a link pin, a bearing box and a cover which braces the bearing box in the housing. The invention further relates to a method for the production of a ball joint, in which the cover is welded to the housing of the ball joint electrically, i.e. by resistance welding.

In motor vehicle technology, modern ball joints are distinguished by a defined friction moment with, at the same time, a high rigidity of the joint. This requirement is achieved for example by the application of a prestressing force onto a ball head of the link pin in the longitudinal direction of the link pin.

In the past, helical springs were preferably used to apply the prestressing force. DE 879 631 for example shows a ball joint in which a link pin is mounted in a housing. The housing is closed by a cover, with a helical spring being arranged between the cover and a ball head of the link pin. The connection between the cover and the housing takes place in DE 879 631 for example by electric resistance welding.

Nowadays, ball joints frequently have a bearing box between the ball head of the link pin and the housing or the cover. The bearing box is slightly compressible here, and the cover itself is mounted in a prestressed manner on the housing so that a spring can be dispensed with. DE 197 56 984 discloses an example of such a ball joint and describes a method for its production. Here, the housing initially holds the bearing box and a ball head of the link pin. The housing is then closed by a cover which is pressed with a desired prestressing force against the bearing box or the link pin. In a final step, the cover is fastened to the housing in its prestressed position by welding, particularly laser welding. The cover is then mounted in a prestressed manner on the housing, so that the applied prestressing force can be removed.

### BRIEF SUMMARY OF THE INVENTION

A feature of the invention is the provision of an alternative, simpler method for the production of a prestressed ball joint.

According to the invention, a method of the type initially mentioned is proposed for the production of a ball joint, in which the cover or the housing has at least one spacer which keeps the cover at an excessively great distance from the housing before welding, with the current then flowing during welding being controlled or regulated in such a way that the at least one spacer melts by a predetermined amount so that the cover is mounted in a prestressed manner on the housing. This offers the advantage that the cover and the housing are connected in a single process step and at the same time are prestressed with respect to each other.

A variant method has proved to be particularly advantageous, in which the cover is welded to the housing by capacitor discharge welding. As the current pulse in capacitor discharge welding is able to be controlled very precisely, the melting path of the spacer can be predetermined accurately. The extent of the prestressing force is in turn influenced directly by this melting path, so that the extent of the prestressing force between the cover and the housing is finally adjusted by the adaptation of welding parameters.

The predetermined amount by which the spacer melts can be adjusted individually. This takes place through a simple variation of the current pulse as a function of given parameters such as, for example, the desired prestress, the manufacturing tolerances of the ball joint components or precise distance measurements between the ball joint components. In addition, a distortion of the components or damage to the box by the introduction of heat is to be ruled out through the short welding time in the millisecond range with a concentration of welding energy only on the welding zone. Thereby, ball joints are able to be produced with a constant or precisely predeterminable prestress, with little expenditure.

The invention further relates to a ball joint with a housing, a link pin, a bearing box and a cover which braces the bearing box in the housing, the cover being provided with at least one spacer which is welded electrically to the housing so that its height has reduced to a predetermined extent.

The spacer here is preferably an annular boss. This ensures on the one hand an encircling tight connection between the cover and the housing and on the other hand has a precise dependence between the welding current pulse and an annular boss melting path.

In one embodiment, the bearing box has a sealing lip which lies against a side of the housing facing the cover. In particular, the sealing lip already lies against the housing before the welding of the ball joint, so that no welding spatter can penetrate between the bearing box and the housing or between the bearing box and the ball head.

The bearing box preferably has a bearing box opening, at least one slit being provided, originating from this bearing box opening, so that the bearing box opening can expand to hold a ball head. The connection between the bearing box and the ball head is thereby particularly simple to produce, although the diameter of the ball head is usually greater than the diameter of the bearing box opening. If the bearing box is manufactured from an elastic material, it acts as a snap box when the ball head is introduced, and is captively connected to the ball head.

In a further embodiment, a contact surface is formed on the bearing box, by which the bearing box engages a contact surface of the cover, the two contact surfaces each having the form of the envelope surface of a frustum. Through this embodiment of the contact surfaces, the force produced during the welding of the cover to brace the bearing box in the housing is transferred very uniformly from the cover to the bearing box.

Preferably, a cone angle of the contact surface of the cover and a cone angle of the contact surface of the bearing box are of different size before the cover is mounted on the housing. The force for bracing the bearing box in the housing thereby increases continuously, the more the height of the spacer is reduced. This offers the advantage that the desired degree of prestress of the joint can be adjusted very precisely.

After the welding of the cover to the housing, the bearing box is preferably elastically prestressed. The prestress of the bearing box increases as the height of the spacer decreases, so that a desired prestress of the joint can be set.

Furthermore, a spring member can be provided which is elastically prestressed after the welding of the cover to the housing. This variant is particularly advantageous if it is not possible to permanently ensure a desired prestress of the joint by means of the ability of the bearing box to be prestressed.

In one embodiment, a flange for fastening the ball joint is integrally formed with the housing. Therefore, the housing also serves at the same time as a fastening member, whereby the number of the individual components and the expenditure for mounting the ball joint can be reduced.

In a further embodiment, the housing is formed in one piece with a steering part of a vehicle. This simplifies the mounting of a vehicle steering and reduces the number of the individual components. Usually, the steering parts (such as chassis struts, tie rods, trailing and transverse links) are made of metal and preferably have an end portion which is configured as a deep-drawn sheet metal housing for the ball joint.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a longitudinal section through a first embodiment of the ball joint according to the invention before the production of the connection between the cover and the housing;

FIG. 2 shows a detail of the ball joint according to the invention in accordance with FIG. 1 before the connection between the cover and the housing;

FIG. 3 shows a detail of the ball joint according to the invention in accordance with FIG. 1 after the connection of the cover and the housing;

FIG. 4 shows a diagram in which the current intensity I and the melting path x are plotted over time t;

FIG. 5 shows a section through the bearing box of a second embodiment of the ball joint according to the invention;

FIG. 6 shows sectional views of the second embodiment of the ball joint according to the invention before and after the production of the connection between the cover and the housing;

FIG. 7 shows a section and a top view of the bearing box of a third embodiment of the ball joint according to the invention;

FIG. 8 shows sectional views of the third embodiment of the ball joint according to the invention before and after the production of the connection between the cover and the housing;

FIG. 9 shows a perspective view of a steering part which constitutes the housing of a ball joint according to the invention;

FIG. 10 shows a perspective view of a fourth embodiment of the ball joint according to the invention; and

FIG. 11 shows a longitudinal section through the ball joint of FIG. 10.

### DETAILED DESCRIPTION OF THE INVENTION

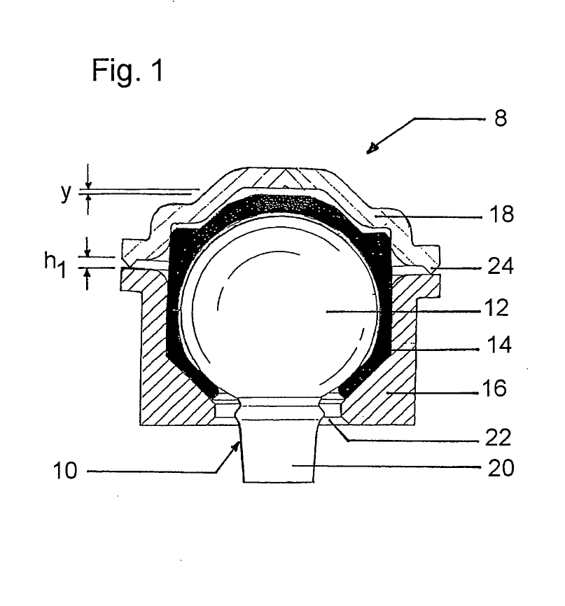

FIG. 1 shows a ball joint 8 according to the invention with a link pin 10 in a first embodiment. A ball head 12 of the link pin 10 is surrounded at least partially by a compressible bearing box 14. The ball head 12 together with the bearing box 14 is held in a recess of a housing 16 which is closed by a cover 18, so that the ball head 12 is completely surrounded by the housing 16 and the cover 18. A pin section 20 of the link pin 10 extends downwards out of the housing 16 through a housing opening 22. The seals which are additionally present, e.g. a sealing bellows, are not shown here because they are of no importance for an understanding of the invention.

In the present example, the cover 18 has a spacer 24 which keeps the cover 18 at an excessively great distance h₁ from the housing 16. The spacer 24 in this case is an encircling annular boss with a triangular ring cross-section, the spacer 24 not having to be constructed so as to be encircling, however, and also being adapted to have semicircular ring cross-sections for example in further embodiments. In addition, it is possible for the housing 16 to have the spacer 24 or that several spacers 24 are provided on the housing 16 and/or on the cover 18.

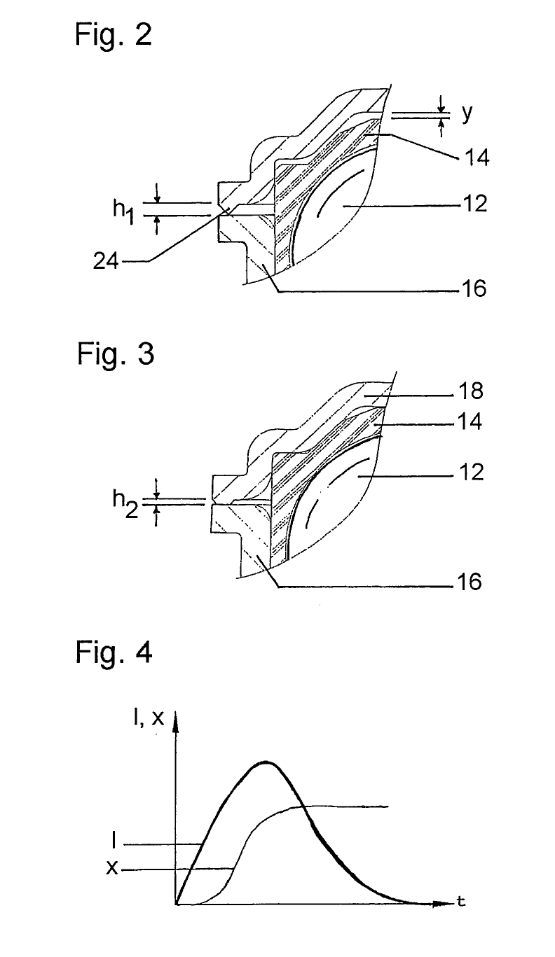

The distance h₁ is designated here as an excessively great distance because it is greater than a play between the cover 18 and the bearing box 14, which is present in a mounted ball joint but with a cover which is only placed loosely. This play is drawn as distance y in FIGS. 1 and 2 and describes the path by which the cover 18 could move without spacer 24 towards the housing 16, until it comes into abutment with the bearing box 14. Accordingly, the spacer 24 must be melted at least by this amount y during welding, so that the ball head 12 of the link pin 10 is mounted free of play in the housing 16 or in the cover 18. The distance y is therefore selected such that during the welding process a melting of the spacer 24 by this amount ensures a secure connection between the cover 18 and the housing 16.

Frequently, a prestress is desired between the housing 16 and the cover 18, in order to provide a ball joint 8 with a defined moment of friction. In such cases, the height h₁ of the spacer 24 must be reduced by a greater amount than the distance y. The more the height h₁ of the spacer 24 is reduced, the greater is the prestress between the cover 18 and the housing 16.

FIG. 2 shows a detail portion of FIG. 1 before the welding of the housing 16 and the cover 18. The play, i.e. the distance y between the bearing box 14 and the cover 18, can be readily seen. The spacer 24, however, keeps the cover 18 at an excessively great distance h₁ from the housing 16, which is greater than the distance y between the bearing box 14 and the cover 18.

FIG. 3 shows the same detail of the ball joint 8 as FIG. 2, but after the welding of the cover 18 to the housing 16. In FIG. 3, the spacer 24 has reduced its height h₁ and now keeps the cover 18 at a distance h₂ from the housing 16. During welding, the spacer 24 is melted by an amount x, which corresponds to the difference between h₁ and h₂, so that the cover 18 is now mounted on the housing 16 at least in a manner free of play and preferably prestressed.

The cover 18 is preferably connected with the housing 16 by capacitor discharge welding. In so doing, a current pulse is provided through a discharge of capacitors, which leads to the melting of the spacer 24. FIG. 4 shows a diagram in which a pattern of the current intensity I of such a current pulse is plotted over time t (pattern drawn in thick line). In this chronological pattern of the current intensity I, the melting path x of the spacer 24 is produced (pattern drawn in thin line). Through a variation in the chronological current pattern I, the melting path x of the spacer 24 can be adjusted such that the cover 18 is mounted on the housing 16 with a desired prestress. As the current pulse can be adapted with little effort in capacitor discharge welding, it is possible to detect the manufacturing tolerances of the individual components with each ball joint 8 and to adjust the current pulse according to the calculated melting path x of the spacer 24.

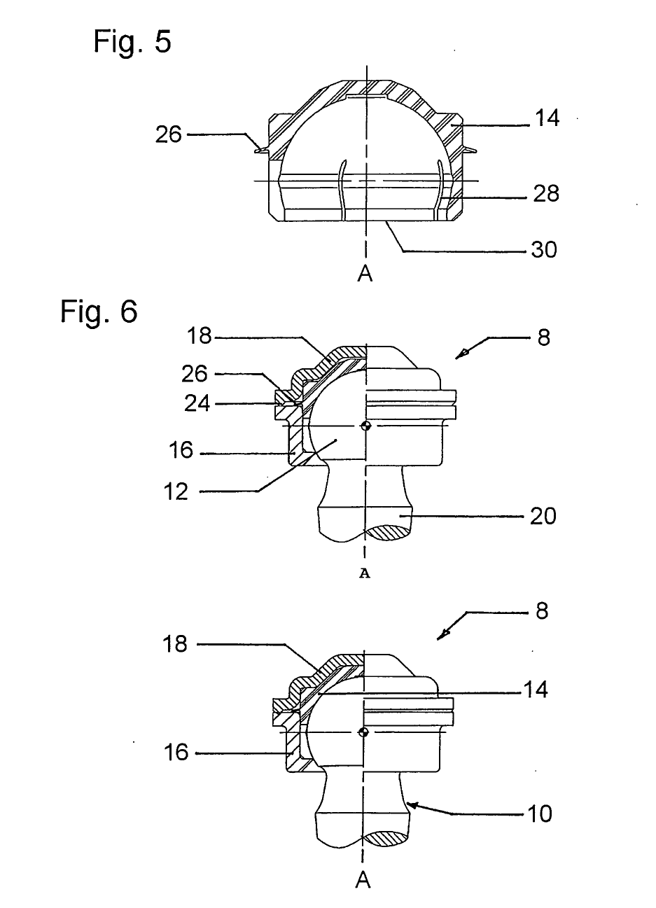

In FIGS. 5 and 6, a second embodiment of the ball joint 8 is shown, which by comparison with the first embodiment only differs in the design of the bearing box 14. In FIG. 5, the bearing box 14 has an encircling sealing lip 26, which already lays onto the housing 16 with slight prestress before the welding of the cover 18 and the housing 16, and prevents the penetration of weld spatter (FIG. 6, top). Viewed in the longitudinal direction of the link pin 10, the sealing lip 26 is situated at the level of the spacer 24 between the cover 18 and the housing 16. The dimension of the sealing lip 26 is preferably smaller than h₂ in this direction, so that the sealing lip 26 does not prevent a movement of the cover 18 towards the housing 16 during the welding process. The situation after welding the ball joint 8 can be seen in FIG. 6 (bottom).

In addition, in the bearing box 14 according to FIG. 5, slits 28 are provided which, originating from a bearing box opening 30, run towards a joint axis A, the slits 28 extending at least up to the maximum box cross-section. When the ball head 12 is introduced, the slits 28 and hence the bearing box opening 30 widen so that the ball head 12 can be held without difficulty in the bearing box 14, although the diameter of the ball head 12 is greater than the diameter of the bearing box opening 30. If the bearing box 14 is made of an elastic material, the bearing box 14 snaps back again into its initial shape according to FIG. 5 after the ball head 12 is introduced, and is captively connected to the link pin 10.

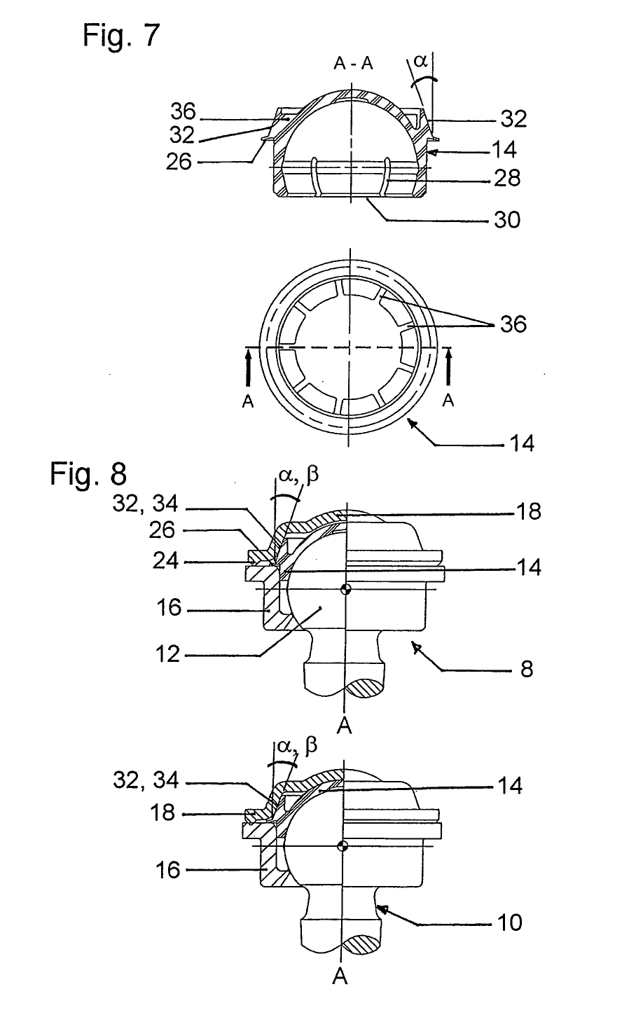

FIGS. 7 and 8 show a third embodiment of the ball joint 8 with an altered bearing box 14 and an altered cover 18. A contact surface 32 (FIG. 7 top) by which the bearing box 14 engages a contact surface 34 of the cover (FIG. 8) is provided on the bearing box 14, the two contact surfaces 32, 34 being each constructed as the envelope surface of a frustum. Before the cover 18 is mounted on the housing 16, the cone angle α of the contact surface 32 of the bearing box 14 and the cone angle β of the contact surface 34 of the cover 18 are of different size. As the bearing box 14 is flexible or compressible, the cone angle α of the bearing box 14 adapts itself by material deformation to the cone angle β of the cover 18, when the cover 18 is placed onto the housing 16 and is welded with it. In so doing, the force for bracing the bearing box 14 in the housing 16 continuously increases with a decreasing distance between the cover 18 and the housing 16. Consequently, the desired degree of prestress of the joint can be adjusted very precisely. If a particularly high degree of prestress of the joint is desired, radial reinforcement cross-pieces 36 with respect to the axis A may be provided for the contact surface 32, which prevent an alteration to the cone angle α by supporting the contact surface 32 substantially over the entire axial extent of the contact surface 32 against the ball head 12. The reinforcement cross-pieces 36 therefore provide for a more rapid increase in force during the welding of the ball joint 8.

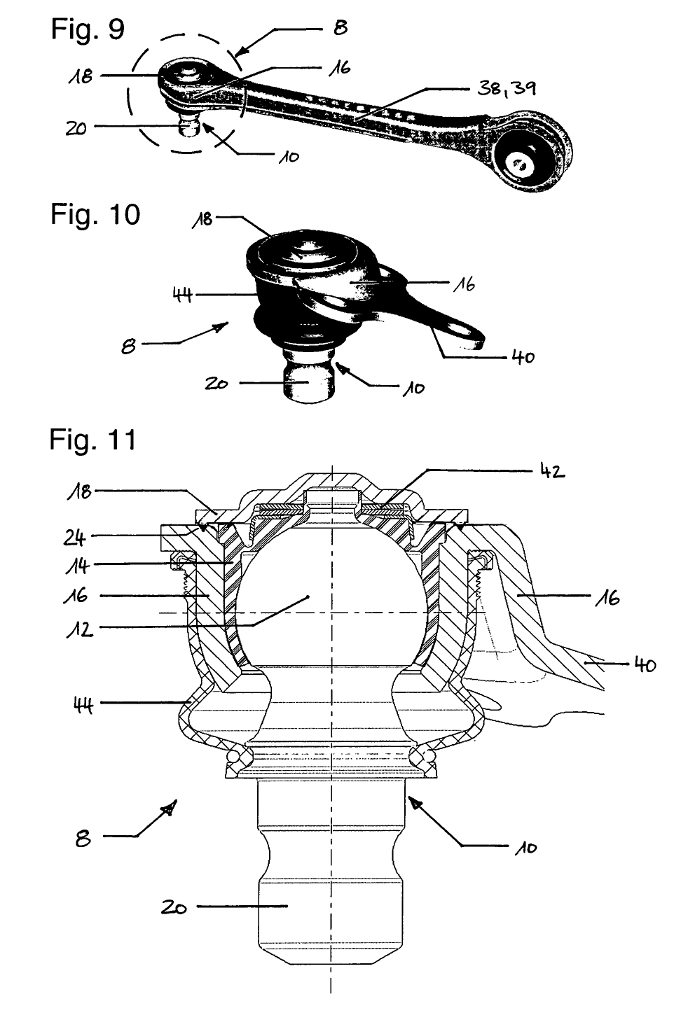

Preferably, the ball joint 8 is integrated into one of the components that are to be articulated to each other. For example, the housing 16 of the ball joint 8 of FIG. 9 is formed in one piece with a steering part 38, more precisely with a radius arm 39. Further steering parts 38 of a vehicle steering into which the ball joint 8 can be integrated are, e.g., chassis struts, tie rods, and trailing and transverse links. Since these steering parts 38 are usually made of metal, preferably of sheet metal, an end portion of the respective steering part 38, for example, can be designed as a deep-drawn housing 16 with little effort.

FIGS. 10 and 11 show a fourth embodiment of the ball joint 8, in which a flange 40 for fastening the ball joint 8 is integrally formed with the housing 16. Such a combination comprised of a housing 16 and a flange 40 can be manufactured particularly easily as a deep-drawn sheet metal part. A further characteristic feature of the ball joint 8 according to FIG. 11 is the spring member 42 between the bearing box 14 and the cover 18. In the present case, the spring member 42 is made up of two disk springs which are prestressed when the spacer 24 is melted during the mounting of the cover 18 to the housing 16. In some variants it can be advantageous to apply an additional joint prestress by means of the spring member 42 to permanently obtain a desired joint performance. However, analogous to the embodiments 1 to 3, the ball joint 8 according to the fourth embodiment can also be configured without spring member 42.

A sealing bellows 44 as is shown by way of example in FIGS. 10 and 11 is usually also provided in all other embodiments to protect the ball joint 8.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. A method for the production of a ball joint, in which a cover is electrically welded to a housing, wherein the cover or the housing has at least one spacer which keeps the cover at an excessively great distance from the housing before welding, and that then the current flowing during welding is controlled or regulated in such a way that the at least one spacer melts by a predetermined amount so that the cover is mounted in a prestressed manner on the housing.

2. The method according to claim 1, wherein the cover is welded to the housing by capacitor discharge welding.

3. The method according to claim 1, wherein the predetermined amount by which the spacer melts, is adjusted individually.

4. A ball joint with a housing, a link pin, a bearing box and a cover which braces the bearing box in the housing, wherein the cover is provided with at least one spacer which is welded electrically to the housing so that its height (h₁) has reduced to a predetermined extent (h₂).

5. The ball joint according to claim 4, wherein the spacer is an annular boss.

6. The ball joint according to claim 4, wherein the bearing box has a sealing lip which lies against a side of the housing facing the cover.

7. The ball joint according to claim 4, wherein the bearing box has a bearing box opening, at least one slit being provided originating from this bearing box opening, so that the bearing box opening can expand to hold a ball head.

8. The ball joint according to claim 4, wherein a contact surface is formed on the bearing box, by which the bearing box engages a contact surface of the cover, the two contact surfaces each having the form of the envelope surface of a frustum.

9. The ball joint according to claim 8, wherein before the cover is mounted on the housing, a cone angle of the contact surface of the bearing box and a cone angle of the contact surface of the cover are of different size.

10. The ball joint according to claim 4, wherein the bearing box is elastically prestressed after the welding of the cover to the housing.

11. The ball joint according to claim 4, wherein a spring member is provided which is elastically prestressed after the welding of the cover to the housing.

12. The ball joint according to claim 4, wherein a flange for fastening the ball joint is integrally formed with the housing.

13. The ball joint according to claim 4, wherein the housing is formed in one piece with a steering part of a vehicle.
